(19) United States
(12) Patent Application Publication
(10) Pub. No.: US 2022/0288580 A1
(43) Pub. Date: Sep. 15, 2022

(54) LIQUID TRANSFER DEVICE

(71) Applicant: iCare Diagnostics International Co. Ltd., New Taipei City (TW)

(72) Inventors: CHIA-HSIN CHANG, New Taipei (TW); CHUN-CHIH CHEN, New Taipei (TW); TING-CHU LEE, New Taipei (TW); SU-HAN HO, New Taipei (TW)

(21) Appl. No.: 17/519,249

(22) Filed: Nov. 4, 2021

(30) Foreign Application Priority Data
Mar. 15, 2021 (CN) 202110277711.3

(51) Int. Cl. B01L 3/02

(52) U.S. Cl. CPC B01L 3/0217; B01L 2200/06; B01L 2200/16; B01L 2400/0478; B01L 2300/087

(57) ABSTRACT

A liquid transfer device includes a transfer unit, a reaction chamber, and a collecting unit. The collecting unit receives a sample solution. The transfer unit includes a piston assembly, a pipette, and a reagent adding unit, a portion of the piston assembly is received in the pipette. The piston assembly moves back and forth along the pipette and the reagent adding unit can receive a reagent. In a first state, the transfer unit is disposed above the collecting unit. In moving away from the collecting unit, the piston deforms the pipe to intake a sample. In a second state, the piston assembly can move closer to the reaction chamber to deform the pipe and release the reacted sample.

### FIELD

The subject matter relates to handling of samples, and more particularly, to a liquid transfer device.

### BACKGROUND

Molecular diagnosis, morphological detection, and immunological detection are mostly carried out in laboratories. Detection processes are time-consuming, complex, inefficient, and inflexible, and detection devices are generally not portable. Transferring of a sample usually need to be done in a laboratory. Therefore, the detection cannot be carried out anytime and anywhere, especially at home.

### BRIEF DESCRIPTION OF THE DRAWINGS

Implementations of the present technology will now be described, by way of example only, with reference to the attached figures.

FIG. 1 is a diagrammatic view of an embodiment of a liquid transfer device according to the present disclosure.

FIG. 2 is an exploded diagrammatic view of the liquid transfer device according to the present disclosure.

FIG. 3 is a cross-sectional view taken along view line of FIG. 1.

FIG. 4 is an exploded diagrammatic view of a transfer unit of the liquid transfer device according to the present disclosure.

FIG. 5 is a cross-sectional view of a first housing of the liquid transfer device according to the present disclosure.

FIG. 6 is an exploded diagrammatic view of a reagent adding unit of the liquid transfer device according to the present disclosure.

FIG. 7 is an exploded diagrammatic view of the reagent adding unit at rest according to the present disclosure.

FIG. 8 is an exploded diagrammatic view of the reagent adding unit when compressed.

FIG. 9 is an exploded diagrammatic view of a reaction chamber of the liquid transfer device according to the present disclosure.

FIG. 10 is a diagrammatic view of a connecting head of the liquid transfer device according to the present disclosure.

FIG. 11 is a diagrammatic view of a collecting unit of the liquid transfer device according to the present disclosure.

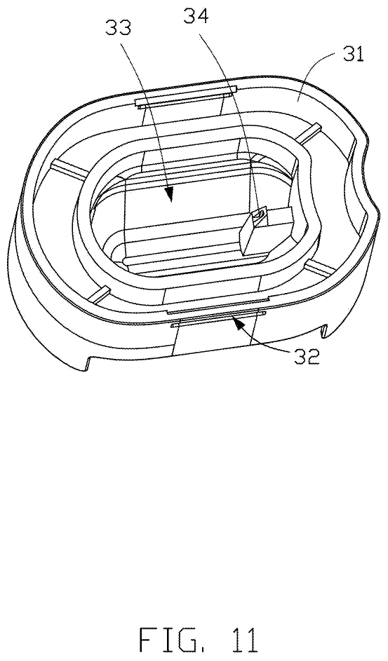

FIG. 12 is a diagrammatic view of a reagent package of the liquid transfer device according to the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

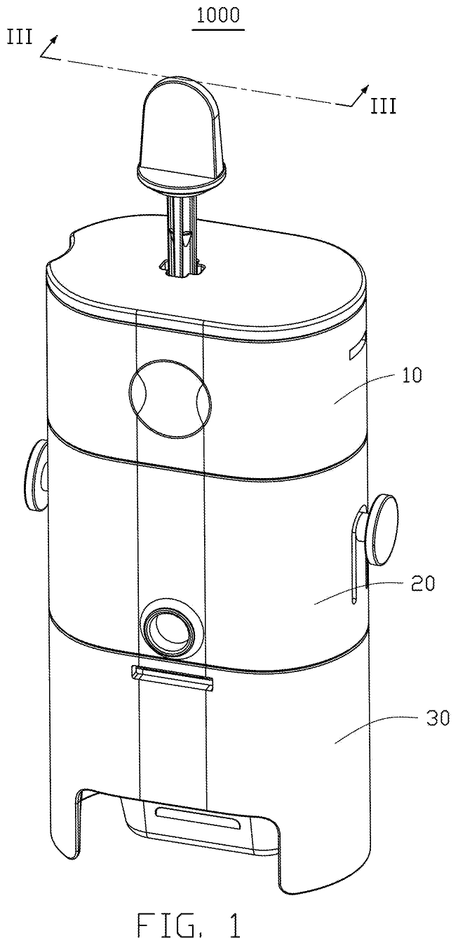

FIGS. 1 to 3 illustrate a liquid transfer device 1000, which includes a transfer unit 10, a reaction chamber 20, and a collecting unit 30. The collecting unit 30 is used to receive a sample solution. The transfer unit 10 includes a piston assembly 11, a pipette 12, and a reagent adding unit 13. Part of the piston assembly 11 is received in the pipette 12. The piston assembly 11 can move back and forth along a central axis of the pipette 12. The pipe 12 can thus be deformed for release or intake of liquid. A reagent is received in the reagent adding unit 13.

In an embodiment, the transfer unit 10, the reaction chamber 20, and the collecting unit 30 are detachably fixed with each other, so that the liquid transfer device 1000 can be switched among a first state, a second state, and a third state. The first state is that the transfer unit 10 is disposed and fixed above the collecting unit 30. The second state is that the transfer unit 10 is disposed and fixed above the reaction chamber 20. The third state is that the reaction chamber 20 is disposed and fixed between the transfer unit 10 and the collecting unit 30.

When the liquid transfer device 1000 is in the first state, the piston assembly 11 can move away from the collecting unit 30 along the central axis of the pipette 12. Therefore, the pipe 12 is deformed to absorb the sample solution in the collecting unit 30. When the liquid transfer device 1000 is in the second state, the piston assembly 11 can move close to the reaction chamber 20 along the central axis of the pipette 12. Therefore, the pipe 12 is deformed to release the sample solution in the reaction chamber 20. The reagent adding unit 13 is used to add the reagent in the reaction chamber 20. The reagent is mixed with the sample solution to form a mixed solution. The piston assembly 11 can move away from the reaction chamber 20 along the central axis of the pipette 12. Therefore, the pipe 12 is deformed to intake the mixed solution. Then the mixed solution in the pipe 12 can be added in a nucleic acid detection device (not shown). The third state of the liquid transfer device 1000 is a resting state. The reaction chamber 20 is disposed and fixed between the transfer unit 10 and the collecting unit 30 for easy storage.

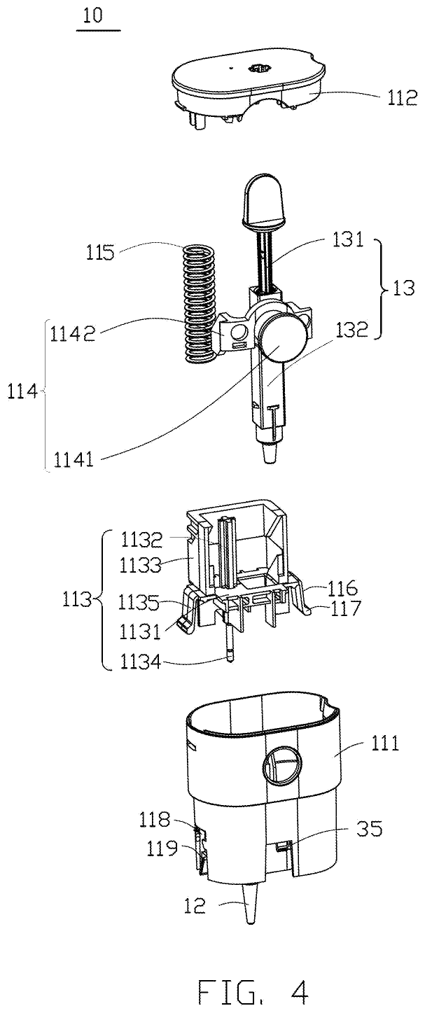

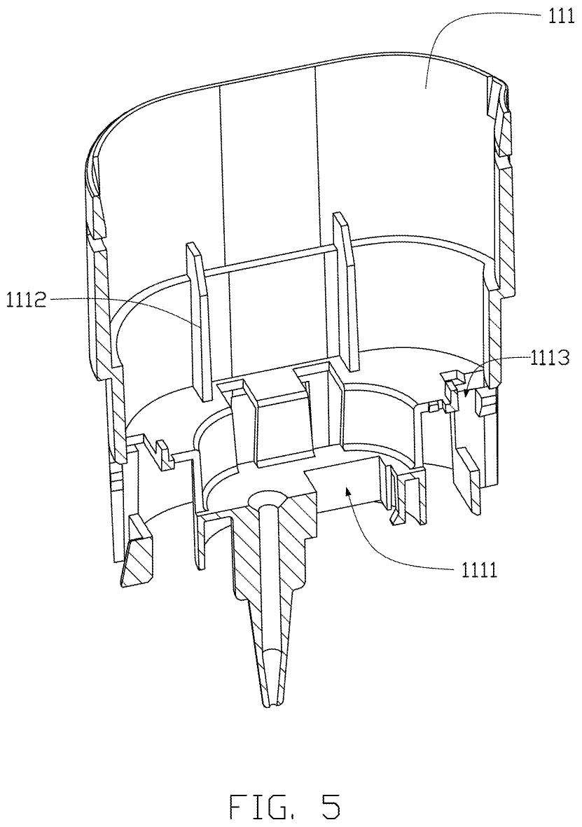

Referring to FIGS. 4 and 5, the piston assembly 11 includes a first housing 111, a top cover 112, a piston 113, a pushing mechanism 114, an elastic member 115, two elastic arms 116, two latching blocks 117, two first latching grooves 118, and two second latching grooves 119. The top cover 112 is disposed on a first end of the first housing 111. The piston 113 is disposed in the first housing 111. The pushing mechanism 114 penetrates the first housing 111 and connects to an end of the piston 113 close to the top cover 112. The elastic member 115 is disposed between the top cover 112 and the piston 113. The two elastic arms 116 are disposed on opposite sidewalls of the piston 113. One latching block 117 is disposed on one end of each elastic arm 116. A sidewall of the first housing 111 defines the first latching grooves 118 and the second latching grooves 119. The first latching grooves 118 are close to the top cover 112, the second latching grooves 119 are away from the top cover 112. The pipette 12 is disposed on the end of the first housing 111 away from the top cover 112 and hermetically connected to the piston 113. Part of the piston 113 is sealed in the pipette 12, and the piston 113 can move back and forth relative to the pipette 12. When the piston 113 is in a lower position, away from the top cover 112, each of the two latching blocks 117 is inserted into a corresponding second latching groove 119. When the piston 113 is in an upper position close to the top cover 112 each of the two latching blocks 117 is inserted into a corresponding first latching groove 118. When the latching blocks 117 are inserted into the first latching grooves 118, the elastic member 115 is compressed, and when the latching blocks 117 are inserted into the second latching grooves 119, the elastic member 115 is in a resting state. When the latching blocks 117 are pressed, and exit from the first latching grooves 118, the piston 113 moves away from the top cover 112 under the elastic restoring force of the elastic member 115 to insert the latching blocks 117 into the second latching grooves 119. At this time, the piston 113 further moves into the pipette 12 to discharge air or liquid held in the pipette 12. The pushing mechanism 114 is used to push the piston 113 to move close to the top cover 112, and the latching blocks 117 exit from the second latching grooves 119 and are inserted into the first latching grooves 118. At this time, the piston 113 gradually exits from the pipette 12. A difference in air pressure between inside and outside of the pipette 12 is formed, and liquid is accordingly sucked into the pipette 12.

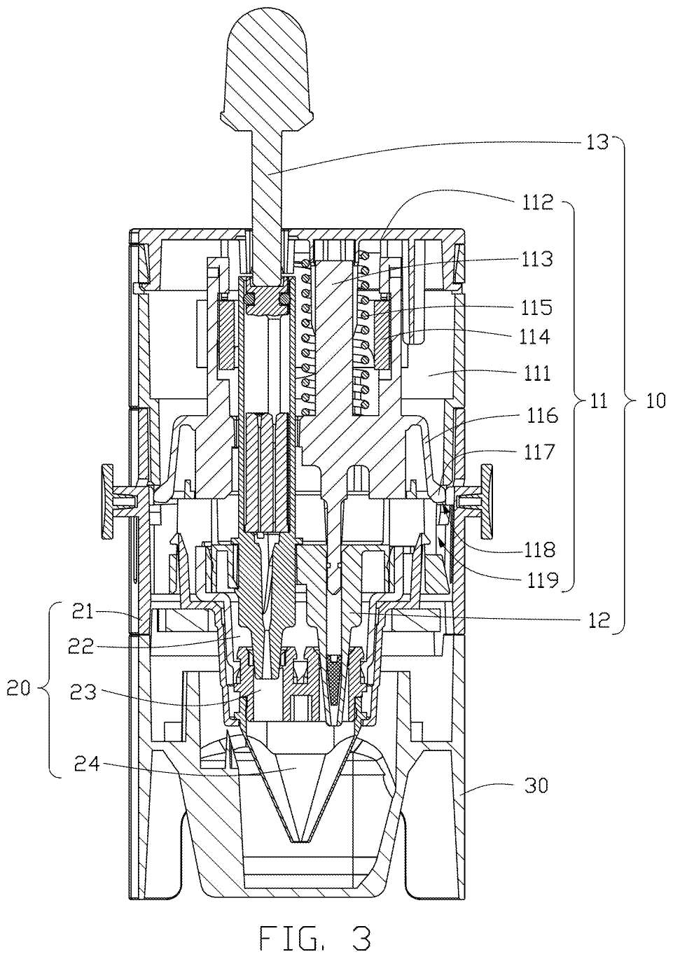

Referring to FIGS. 3 to 5, the first housing 111 is substantially a hollow cylinder. A cross section of the first housing 111 is substantially elliptical. The top cover 112 covers the first end of the first housing 111. The pipette 12 is disposed on a second end of the first housing 111 away from the top cover 112. The pipette 12 and the first housing 111 are integrally formed. The first end of the first housing 111 defines an opening 1111 which is corresponding to the pipette 12. One end of the reagent adding unit 13 penetrates the top cover 112, and the other end of the reagent adding unit 13 passes through the opening 1111. The first housing 111 also includes a plurality of stop bars 1112. The stop bars 1112 are used to fix the piston 113 and guide the piston 113 to move back and forth along the first housing 111.

In an embodiment, referring to FIG. 5, the piston 113 includes a piston body 1131, a guiding rod 1132 disposed on an end of the piston body 1131 close to the top cover 112, two guiding plates 1133 disposed on opposite sidewalls of the guiding rod 1132, and a piston rod 1134 disposed on an end of the piston body 1131 away from the top cover 112. The elastic member 115 is sleeved on the guiding rod 1132. One end of the elastic member 115 connects to the top cover 112 and the other end of the elastic member 115 connects to the piston body 1131. The piston rod 1134 is hermetically connected to the pipette 12 through a sealing ring (not shown). The piston rod 1134 can move back and forth along the central axis relative to the pipette 12.

Referring to FIGS. 3 and 4, the pushing mechanism 114 includes a first pressing head 1141 and a moving slider 1142. The moving slider 1142 penetrates the sidewall of the first housing 111. The first pressing head 1141 is disposed on an outside of the first housing 111 and clamped with the moving slider 1142. One end of the moving slider 1142 away from the first pressing head 1141 is connected to a guiding rail 1135 on the guiding plate 1133. The first pressing head 1141 can be pressed to push the moving slider 1142 to move back and forth relative to the guiding rail 1135. Therefore, the piston 113 can be pushed towards the top cover 112. A force in a horizontal direction can be converted in a vertical direction through the pushing mechanism 114, to realize movement of the piston 113 in the vertical direction.

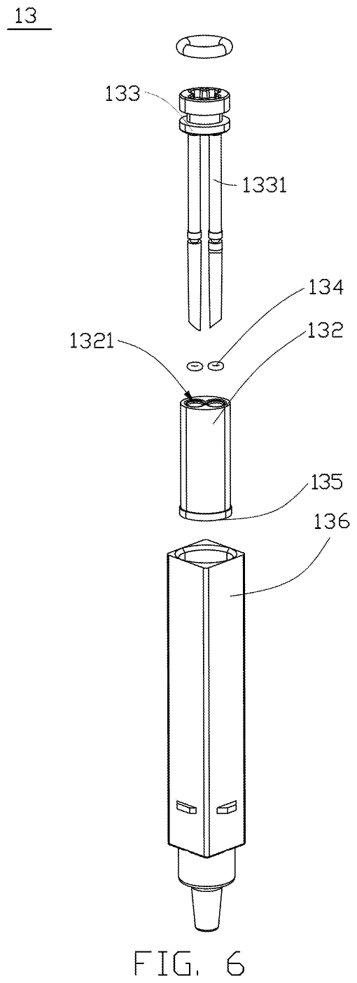

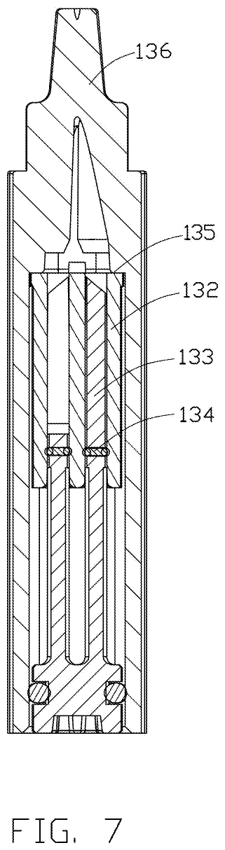

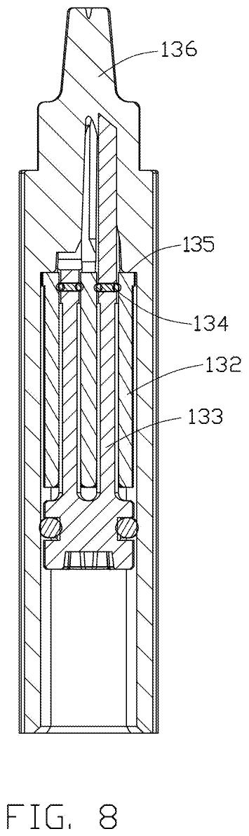

Referring to FIGS. 3, 4, and 6 to 8, the reagent adding unit 13 includes a pressing rod 131 passing through the top cover 112, a reagent tube portion 132 disposed on an end of the pressuring rod 131 away from the top cover 112, an inserting member 133 extended in the reagent tube portion 132 from one end of the reagent tube 132, a sealing film 135 disposed on the other end of the reagent tube portion 132, a sealing ring 134 disposed between the inserting member 133 and the reagent tube 132, and a fixed tube 136 sleeved on an outside of the reagent tube portion 132. Both ends of the fixed tube 136 are open. One end of the fixed tube 136 is close to the pressuring rod 131, and the other end is close to the reaction chamber 20. A bottom end of the pressuring rod 131 is connected to a top end of the inserting member 133. Referring to FIG. 7, in an initial state, a tip of the inserting member 133 does not pierce the sealing film 135. Referring to FIG. 8, the pressuring rod 131 can be pressed to push the inserting member 133 to move towards the reaction chamber 20. The tip of the inserting member 133 will thus pierce the sealing film 135 to allow the reagent in the reagent tube portion 132 to flow into the reaction chamber 20.

In an embodiment, the reagent tube portion 132 has two tubes 1321, able to receive two kinds of regents. The two tubes 1321 are disposed side by side in the reagent tube portion 132. The inserting member 133 includes two inserting rods 1331 corresponding to the two tubes 1321 in the reagent tube portion 132. The two inserting rods 1331 insert into the two tubes 1321 to release the reagents in the reagent tube portion 132 together. The reagent tube portion 132 can receive two different reagents, which allows a reaction in the reaction chamber 20 to be more convenient. There is no need to open the liquid transfer device 1000 to add sample and reagents into the reaction chamber 20, this avoids contamination of the reaction affecting a detection result.

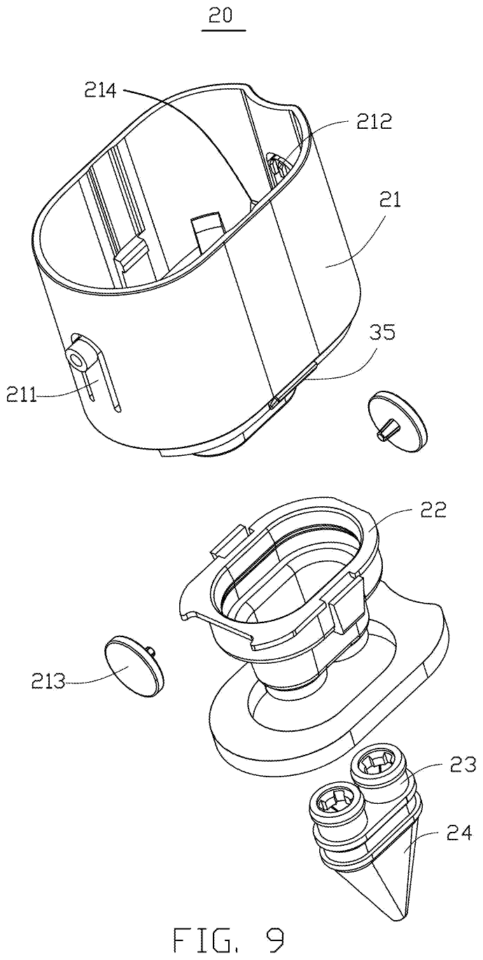

Referring to FIGS. 3, 9, and 10, the reaction chamber 20 includes a second housing 21, a collector 22 disposed in the second housing 21, a connector 23 disposed below the collector 22, and a reaction cup 24 disposed below the connector 23.

In an embodiment, the second housing 21 includes two elastic sheets 211, a protrusion 212 disposed on an inner sidewall of each elastic sheet 211, and a second pressing head 213 disposed on an outer sidewall of each elastic sheet 211. When the reaction chamber 20 is connected to the transfer unit 10, the two protrusions 212 are aligned with the two first latching grooves 118 on the first housing 111. The second pressing head 213 can be pressed to bend the elastic sheet 211 inward. Therefore, the protrusion 212 can press the latching blocks 117 to exit from the first latching grooves 118.

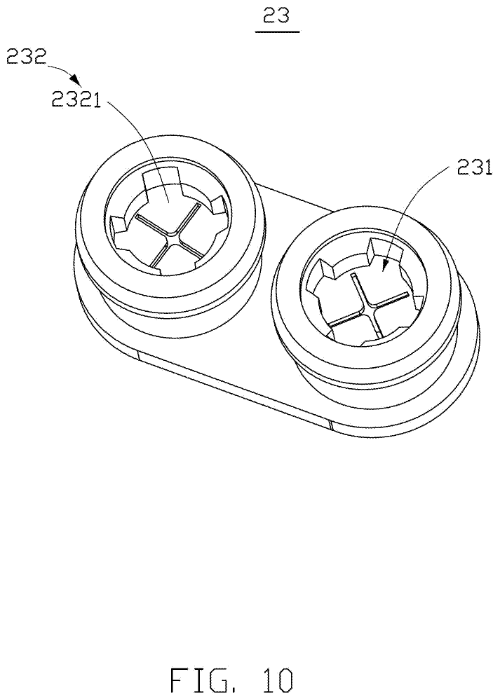

In an embodiment, the connector 23 defines two through holes 231 corresponding to the pipette 12 and the reagent adding unit 13 respectively. The collector 22 is connected to the cuvette 24 through the two through holes 231. A baffle 232 is disposed in each through hole 231. Before the pipette 12 or the reagent adding unit 13 is inserted into the reaction chamber 20, the baffle 232 is closed and seals the cuvette 24. When sampling is required, the pipette 12 or the reagent adding unit 13 can pass through the baffle 232 and be inserted into the cuvette 24. Referring to FIG. 10, the baffle 232 includes a plurality of blades 2321. The blades 2321 are elastic. When the pipette 12 or the reagent adding unit 13 is inserted into the through hole 231, the blades 2321 bend and extend into the cuvette 24.

In an embodiment, the cuvette 24 is substantially a conical cup which is conducive to the transfer of a trace sample.

In an embodiment, the collecting unit 30 includes a third housing 31, at least one third latching groove 32 disposed on a sidewall of the third housing 31, a collection cup 33 disposed inside the third housing 31, and a puncture portion 34 disposed in the collection cup 33. Each of the transfer unit 10 and the reaction chamber 20 corresponding to the third latching groove 32 includes at least one clamping position 35. The collecting unit 30 is connected to the transfer unit 10 or the reaction chamber 20 through the clamping of the clamping positions 35 with the third latching groove 32.

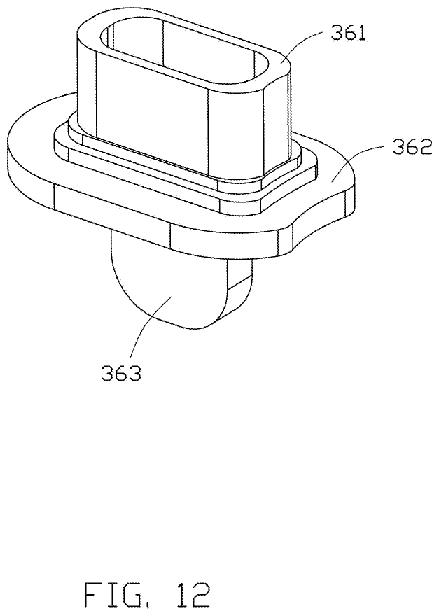

Referring to FIG. 12, the collecting unit 30 further includes a reagent box 36, which can be put into the collection cup 33. The reagent box 36 can be pierced through the puncture portion 34 to allow the reagent to flow into the collection cup 33.

In an embodiment, the reagent box 36 includes a reagent adding opening 361, a gasket 362 disposed below the reagent adding opening 361, and a reagent package 363 disposed below the gasket 362 and connected to the reagent adding opening 361. A material of the reagent package 363 is such that it may be easily pierced, such as tin foil paper or plastic film.

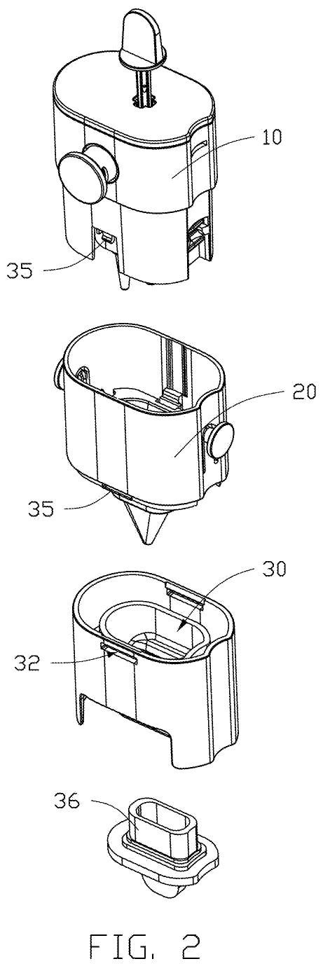

Referring to FIGS. 2, 5, and 9, when the transfer unit 10, the reaction chamber 20, and the collecting unit 30 are assembled, hooks 214 disposed on the second housing 21 are clamped into clamping grooves 1113 disposed on the first housing 111, so as to connect the transfer device 10 to the reaction chamber 20. Clamping parts 35 disposed on the reaction chamber 20 or the transfer device 10 can be inserted into the third latching grooves 32 disposed on the collecting unit 30, so as to lock the reaction chamber 20 or the transfer device 10 into the collection device 30. Sealing rings (not shown) are disposed on assembled joints for sealing purposes. Throughout the assembling process, the sample solution and the reagents are sealed in the liquid transfer device 1000 to prevent contamination.

Initially, the liquid transfer device 1000 is in the third state. When in use, the collecting unit 30 and the transfer unit 10 are removed from the reaction chamber 20. Then, the sample solution to be tested is placed in the collecting unit 30. The liquid transfer device 1000 is switched to the first state. The piston assembly 11 moves away from the collecting unit 30 relative to the pipette 12, so that the pipette 12 absorbs the sample solution. Then, the liquid transfer device 1000 is switched to the second state. The piston assembly 11 moves towards the reaction chamber 20 relative to the pipette 12, so that the pipette 12 discharges the sample solution into the reaction chamber 20. The reagents in the reagent adding unit 13 are added in the reaction chamber 20 to mix with the sample solution to form the mixed solution. The piston assembly 11 moves away from the reaction chamber 20 relative to the pipette 12 to make the pipette 12 absorb the mixed solution in the reaction chamber 20. Finally, the transfer unit 10 transfers the mixed solution to a nucleic acid detection device for example, for detection.

Referring to FIGS. 1 to 10, a method for using the liquid transfer device 1000 includes the following steps.

At step one, the second pressing head 213 on the sidewall of the transfer unit 10 is pressed to push the latching blocks 117 to exit from the first latching grooves 118. An elastic restoring force of the elastic member 115 drives the piston 113 to move downward, and the latching blocks 117 are inserted in the second latching grooves 119 to discharge the air in the pipette 12.

At step two, the clamping position 35 on the transfer unit 10 is clamped into the third latching groove 32 on the collecting unit 30, so as to lock the transfer unit 10 on the collecting unit 30. Therefore, the pipette 12 extends into the collection cup 33 of the collecting unit 30.

At step three, the pushing mechanism 114 is pressed to make the latching blocks 117 exit from the second latching grooves 119 and move upward to clamp into the first latching grooves 118. At this time, the piston 113 is driven to move upward to make the pipette 12 absorb a quantified amount of the sample solution in the collection cup 33.

At step four, the transfer device 10 is separated from the collecting unit 30 and locked with the reaction chamber 20. The pipette 12 is inserted into the reaction cup 24 through the collector 22 and one through hole 231 on the connector 23. The regent adding unit 13 is inserted into the reaction cup 24 through the collector 22 and another through hole 231 on the connector 23.

At step five, the second pressing head 213 is pressed again, and the latching blocks 117 exit from the first latching grooves 118. The elastic restoring force of the elastic member 115 drives the piston 113 downward. Therefore, the latching blocks 117 are inserted into the second latching grooves 119 to inject the sample solution in the pipette 12 into the cuvette 24.

At step six, the pressuring rods 131 on the reagent adding unit 13 are pressed to push the inserting members 133 downward, so as to pierce the sealing films 135 at the bottom end of the reagent tube portion 132. Therefore, the reagents in the reagent tube portion 132 can enter the cuvette 24.

The liquid transfer device 1000 provided by the present disclosure can be used to transfer a variety of liquids. For example, samples of the liquid may be, but are not limited to, a biological sample, a veterinary sample, or an environmental sample.

The liquid transfer device 1000 provided by the present disclosure can be used to collect and prepare volumes of 1 μl˜5 ml (such as 1 μl, 2 μl, 4 μl, 5 μl, 10 μl, 20 μl, 50 μl. 100 μl, 200 μl, 500 μl. 1 ml, 2 ml, and 5 ml of liquid), and volumes in between.

The liquid transfer device 1000 has the advantages of simple overall structure, low cost, and convenient operation.

The disassembly and assembly of the transfer unit 10, the reaction chamber 20, and the collecting unit 30 of the liquid transfer device 1000 are simple and convenient. The piston assembly 11 and the reagent adding unit 13 are received in the transfer unit 10, which avoids opening the liquid transfer device 1000 to add samples during the reaction process. Therefore, the sealing performance of the liquid transfer device 1000 is improved to avoid contamination of the reaction. Thus, the liquid transfer device 1000 has a simple structure, which is portable, flexible, and convenient, and can be used at home.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure, up to and including the full extent established by the broad general meaning of the terms used in the claims.

What is claimed is:

1. A liquid transfer device, comprising:
a transfer unit,
a reaction chamber; and
a collecting unit;
wherein the collecting unit is configured to receive a sample solution, the transfer unit comprises a piston assembly, a pipette, and a reagent adding unit, a portion of the piston assembly is received in the pipette, the piston assembly is configured to move back and forth along the pipette, the reagent adding unit is configured to receive a reagent;
wherein the liquid transfer device is adapted to be switched between a first state and a second state, when in the first state, the transfer unit is disposed above the collecting unit, the piston assembly is configured to move away from the collecting unit, causing the pipe to be deformed to absorb the sample solution in the collecting unit; when in the second state, the transfer unit is disposed above the reaction chamber, the piston assembly is configured to move close to the reaction chamber, causing the pipe to be deformed to release the sample solution in the reaction chamber, the reagent adding unit is further configured to add the reagent in the reaction chamber to cause the reagent to be mixed with the sample solution to form a mixed solution, the piston assembly is configured to move away from the reaction chamber, causing the pipe to be deformed to intake the mixed solution.

2. The liquid transfer device of claim 1, wherein the piston assembly comprises a first housing, a top cover, a piston, a pushing mechanism, an elastic member, two elastic arms, two latching blocks, two first latching grooves, and two second latching grooves, the top cover is disposed on an end of the first housing, the piston is disposed in the first housing, the pushing mechanism penetrates into the first housing and connects to an end of the piston close to the top cover, the elastic member is disposed between the top cover and the piston, the two elastic arms are disposed on opposite sidewalls of the piston, each of the two latching blocks is disposed on one end of a corresponding elastic arm, a sidewall of the first housing defines the two first latching grooves and the two second latching grooves, the two first latching grooves are close to the top cover and the two second latching grooves are away from the top cover;
the pipette is disposed on an end of the first housing away from the top cover and hermetically connected to the piston, and the piston is configured to move back and forth relative to the pipette;
each of the two latching blocks is configured to be inserted into a corresponding one of the two first latching grooves or a corresponding one of the two second latching grooves, when the two latching blocks are inserted into the two first latching grooves, the elastic member is compressed, and when the two latching blocks are inserted into the two second latching grooves, the elastic member is in an original state.

3. The liquid transfer device of claim 2, wherein the piston comprises a piston body, a guiding rod disposed on an end of the piston body close to the top cover, two guiding plates disposed on opposite sidewalls of the guiding rod, and a piston rod disposed on an end of the piston body away from the top cover, the elastic member is sleeved on the guiding rod, one end of the elastic member connects to the top cover and the other end connects to the piston body, the piston rod is hermetically connected to the pipette, the piston rod is configured to move back and forth relative to the pipette.

4. The liquid transfer device of claim 2, wherein the pushing mechanism comprises a first pressing head and a moving slider, the moving slider penetrates the sidewall of the first housing, the first pressing head is disposed on an outside of the first housing and clamped with the moving slider, the first pressing head is configured to push the moving slider to move back and forth, causing the piston to move towards the top cover.

5. The liquid transfer device of claim 4, wherein the pushing mechanism further comprises a guiding rail disposed on the guiding plate, the end of the moving slider away from the first pressing head is connected to the guiding rail, the first pressing head is configured to push the moving slider to move back and forth relative to the guiding rail.

6. The liquid transfer device of claim 2, wherein the reagent adding unit comprises a pressuring rod passed through the top cover, a reagent tube portion disposed on an end of the pressuring rod away from the top cover, an inserting member extended in the reagent tube from one end of the reagent tube portion, a sealing film disposed on the other end of the reagent tube portion, a sealing ring disposed between the inserting member and the reagent tube portion, and a fixed tube sleeved on an outside of the reagent tube portion, a bottom end of the pressuring rod is connected to a top end of the inserting member, the pressuring rod is configured to push the inserting member to move towards the reaction chamber to pierce the sealing film, causing a reagent in the reagent tube portion to flow out.

7. The liquid transfer device of claim 6, wherein the inserting member comprises a tip, and the tip is configured to pierce the sealing film.

8. The liquid transfer device of claim 6, wherein the reagent tube portion comprises two tubes disposed side by side in the reagent tube portion, the inserting member comprises two inserting rods corresponding to the two tubes, the two inserting rods insert into a corresponding one of the two tubes.

9. The liquid transfer device of claim 1, wherein the reaction chamber comprises a second housing, a collector disposed in the second housing, a connector disposed below the collector, and a reaction cup disposed below the connector, the collector is connected to the reaction cup through the connector.

10. The liquid transfer device of claim 9, wherein the connector defines two through holes corresponding to the pipette and the reagent adding unit respectively, the collector is connected to the cuvette through the two through holes, a baffle is disposed in each through hole, the baffle comprises a plurality of blades, each of the plurality of blades is elastic, the plurality of blades is capable of being opened to connect the collector to the reaction cup, and is capable of being closed to disconnected the collector from the reaction cup.

11. The liquid transfer device of claim 1, wherein the collecting unit comprises a third housing, at least one third latching groove disposed on an inner sidewall of the third housing, a collection cup disposed inside the third housing, and a puncture portion disposed in the collection cup.

12. The liquid transfer device of claim 11, wherein the collecting unit further comprises a reagent box detachably disposed in the collection cup, the puncture portion is configured to piece the reagent box to make a reagent to flow into the collection cup.

13. The liquid transfer device of claim 12, wherein the reagent box comprises a reagent adding opening, a gasket disposed below the reagent adding opening, and a reagent package disposed below the gasket and connected to the reagent adding opening, the puncture portion is configured to pierce the reagent package.
